(19) United States
(12) Patent Application Publication
(10) Pub. No.: US 2010/0265414 A1
(43) Pub. Date: Oct. 21, 2010

(54) COMBINED VIDEO AND AUDIO BASED AMBIENT LIGHTING CONTROL

(75) Inventor: Erik Nieuwlands, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/294,623

(22) PCT Filed: Mar. 27, 2007
(86) PCT No.: PCT/IB07/51075

§ 371 Date: Sep. 26, 2008

Related U.S. Application Data
(60) Provisional application No. 60/788,467, filed on Mar. 31, 2006.
(60) Provisional application No. 60/866,648, filed on Nov. 21, 2006.

(51) Int. Cl. H04N 5/66

(52) U.S. Cl. 348/739; 348/E05.133

(57) ABSTRACT

A method for controlling an ambient lighting element including determining ambient lighting data to control an ambient lighting element. The method includes processing combined ambient lighting data, wherein the combined ambient lighting data is based on corresponding video content portions and corresponding audio content portions. The processed combined ambient lighting data may then be used to control an ambient lighting element. In one embodiment, the combined ambient lighting data may be received as a combined ambient lighting script. Video-based ambient lighting data and audio-based ambient lighting data may be combined to produce the combined ambient lighting data. Combining the video-based and audio-based ambient lighting data may include modulating the video-based ambient lighting data by the audio-based ambient lighting data. The video content and/or audio content may be analyzed to produce the video-based and/or audio-based ambient lighting data.

This application claims the benefit of U.S. Provisional Patent Application No. 60/788,467, filed Mar. 31, 2006.

The present system relates to ambient lighting effects that are modulated by characteristics of a video and audio content stream.

Koninklijke Philips Electronics N.V. (Philips) and other companies have disclosed means for changing ambient or peripheral lighting to enhance video content for typical home or business applications. Ambient lighting modulated by video content that is provided together with a video display or television has been shown to reduce viewer fatigue and improve realism and depth of experience. Currently, Philips has a line of televisions, including flat panel televisions with ambient lighting, where a frame around the television includes ambient light sources that project ambient light on the back wall that supports or is near the television. Further, light sources separate from the television may also be modulated relative to the video content to produce ambient light that may be similarly controlled.

In a case of a single color light source, modulation of the light source may only be a modulation of the brightness of the light source. A light source capable of producing multi-color light provides an opportunity to modulate many aspects of the multi-color light source based on rendered video including a wide selectable color range per point.

It is an object of the present system to overcome disadvantages in the prior art and/or to provide a more dimensional immersion in an ambient lighting experience.

The present system provides a method, program and device for determining ambient lighting data to control an ambient lighting element. The method includes processing combined ambient lighting data, wherein the combined ambient lighting data is based on corresponding video content portions and corresponding audio content portions. The processed combined ambient lighting data may then be used to control an ambient lighting element. In one embodiment, the combined ambient lighting data may be received as a combined ambient lighting script or as separate video-based and audio-based ambient lighting scripts.

Video-based ambient lighting data and audio-based ambient lighting data may be combined to produce the combined ambient lighting data. Combining the video-based and audio-based ambient lighting data may include modulating the video-based ambient lighting data by the audio-based ambient lighting data.

In one embodiment, video content and/or audio content may be analyzed to produce the video-based and/or audio-based ambient lighting data. Analyzing the video content may include analyzing temporal portions of the video content to produce temporal portions of video-based ambient lighting data. In this embodiment, the temporal portions of video-based ambient lighting data may be combined to produce a video-based ambient lighting script as the video-based ambient lighting data.

The audio content may be analyzed to produce the audio-based ambient lighting data. Analyzing the audio content may include analyzing at least one of a frequency, a frequency range, and amplitude of the corresponding audio content portions. Analyzing the audio content may identify and utilize other characteristics of the audio content including beats per minute; key, such as major and minor keys, and absolute key of the audio content; intensity; and/or classification such as classical, pop, discussion, movie. Further, data may be analyzed that is separate from the audio itself, but that may be associated with the audio data, such as meta-data that is associated with the audio data. Combining the video-based and audio-based ambient lighting data may include utilizing the audio-based ambient lighting data to adjust dynamics of a color point determined utilizing the video-based ambient lighting data.

The present system is explained in further detail, and by way of example, with reference to the accompanying drawings wherein:

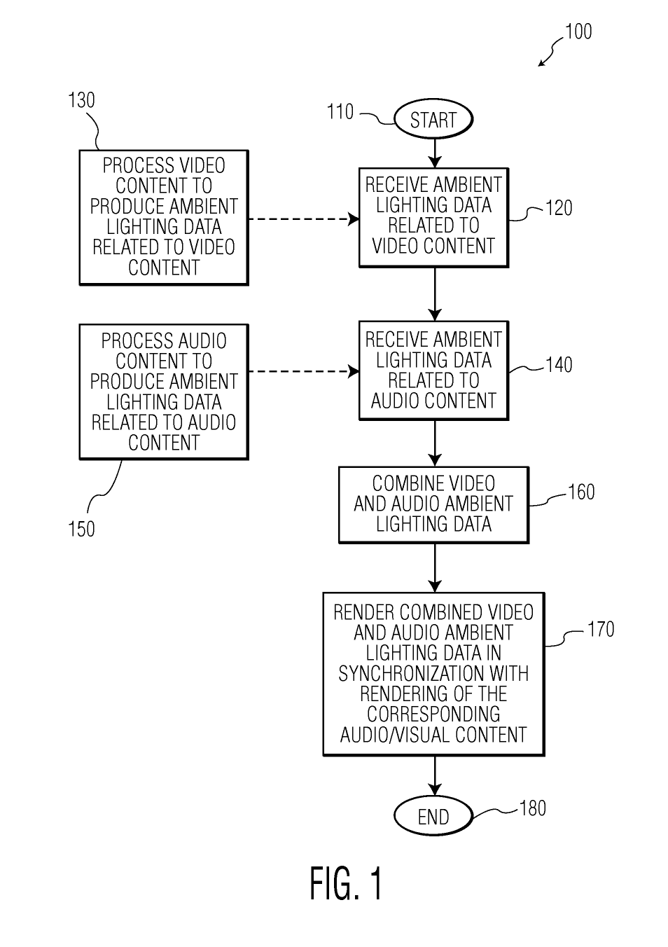

FIG. 1 shows an a flow diagram in accordance with an embodiment of the present system; and

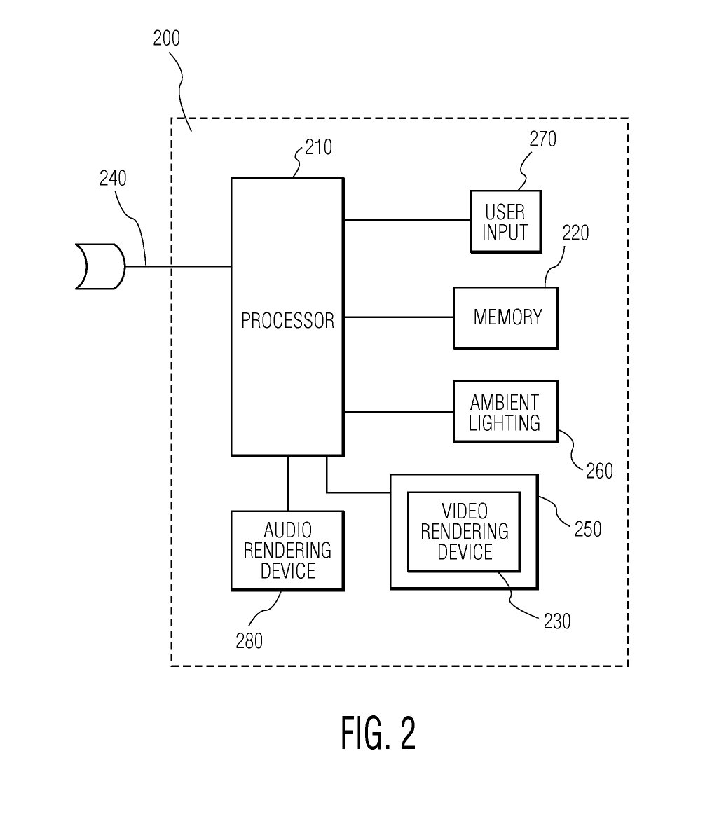

FIG. 2 shows a device in accordance with an embodiment of the present system.

The following are descriptions of illustrative embodiments that when taken in conjunction with the following drawings will demonstrate the above noted features and advantages, as well as further ones. In the following description, for purposes of explanation rather than limitation, specific details are set forth such as the particular architecture, interfaces, techniques, etc., for illustration. However, it will be apparent to those of ordinary skill in the art that other embodiments that depart from these specific details would still be understood to be within the scope of the appended claims. Moreover, for the purpose of clarity, detailed descriptions of well-known devices, circuits, and methods are omitted so as not to obscure the description of the present system.

It should be expressly understood that the drawings are included for illustrative purposes and do not represent the scope of the present system.

FIG. 1 shows a flow diagram 100 in accordance with an embodiment of the present system. During act 110, the process begins. Thereafter, during act 120, ambient lighting data related to video content, hereinafter termed video-based ambient lighting data, is received. The video-based ambient lighting data may be received in a form of a light script that is produced internal or external to the system, such as disclosed in International Patent Application Serial No. IB2006/053524 (Attorney Docket No. 003663) filed on Sep. 27, 2006, which claims the benefit of U.S. Provisional Patent Application Ser. Nos. 60/722,903 and 60/826,117, all of which are assigned to the assignee hereof, and the contents of all which are incorporated herein by reference in their entirety. In one embodiment, the light script is produced external to the system, for example by a light script authoring service that provides a light script related to particular video content. The light script may be retrieved from an external source accessible, for example, from a wired or wireless connection to the Internet. In this embodiment, video content or a medium bearing the video content may include an identifier for the content and/or an identifier may be discernable from the content directly. The identifier may be utilized to retrieve a light script that corresponds to the video content. In another embodiment, the light script may be stored or provided on the same medium as the audio-visual content. In this embodiment, the identifier may be unnecessary for retrieving the corresponding light script.

In another embodiment, the video content may be processed to produce the video-based ambient lighting data related to the video content during act 130. The processing, in a form of analyzing the video content or portions thereof, may be performed just prior to rendering the video content or may be performed on stored or accessible video content. PCT Patent Application WO 2004/006570 incorporated herein by reference as if set out in entirety discloses a system and device for controlling ambient lighting effects based on color characteristics of content, such as hue, saturation, brightness, colors, speed of scene changes, recognized characters, detected mood, etc. In operation, the system analyzes received content and may utilize the distribution of the content, such as average color, over one or more frames of the video content or utilize portions of the video content that are positioned near a border of the one or more frames to produce the video-based ambient lighting data related to the video content. Temporal averaging may be utilized to smooth out temporal transitions in the video-based ambient lighting data caused by rapid changes in the analyzed video content.

International Patent Application Serial No. IB2006/053524 also discloses a system for analyzing video content to produce video-based ambient lighting data related to the video content. In this embodiment, pixels of the video content are analyzed to identify pixels that provide a coherent color while incoherent color pixels are discarded. The coherent color pixels are then utilized to produce the video-based ambient lighting data.

The are numerous other system for determining the video-based ambient lighting data including histogram analysis of the video content, analysis of the color fields of video content, etc. As may be readily appreciated by a person of ordinary skill in the art, any of the systems may be applied to produce the video-based ambient lighting data in accordance with the present system.

The video-based ambient lighting data may include data to control ambient lighting characteristics such as hue, saturation, brightness, color, etc. of one or more ambient lighting elements. For example, in one embodiment in accordance with the present system, the video-based ambient lighting data determines time-dependent color points of one or more ambient lighting elements to correspond to video content.

During act 140, the present system receives ambient lighting data related to the audio content, hereinafter termed audio-based ambient lighting data. The audio-based ambient lighting data may, similar to the video-based ambient lighting data, be received in the form of an audio-based ambient lighting script. In one embodiment, the audio-based light script is produced external to the system, for example by a light script authoring service that provides a light script related to particular audio content. The light script may be retrieved from an external source accessible, for example, from a wired or wireless connection to the Internet. In this embodiment, audio content or a medium bearing the audio content may include an identifier for the content and/or an identifier may be discernable from the content directly. In another embodiment, the identifier determined from the video content may be utilized for retrieving the audio-based light script as the audio content typically corresponds to the video content of audio-visual content. In any event, the identifier, whether it be audio-based or video-based, may be utilized to retrieve a light script that corresponds to the audio content. In one embodiment, the audio-based light script may be accessible, for example, from a medium wherein the audio-visual content is stored without the use of an identifier.

In another embodiment, the audio content may be processed to produce the audio-based ambient lighting data related to the audio content during act 150. The processing, in a form of analyzing the audio content or portions thereof, may be performed just prior to rendering the audio-visual content or may be performed on stored or accessible audio content. Audio analysis to produce the audio-based ambient lighting data may include analysis of a frequency of the audio content, a frequency-range of the audio content, energy of the audio content, amplitude of audio energy, beat of audio content, tempo of audio content, and other systems for determining characteristics of the audio content as may be readily applied. In another embodiment, histogram analysis of the audio content may be utilized, such as audio-histogram analysis in a frequency domain. Temporal averaging may be utilized to smooth out temporal transitions in the audio-based ambient lighting data caused by rapid changes in the analyzed audio content. Analyzing the audio content may identify and utilize other characteristics of the audio content including beats per minute; key, such as major and minor keys, and absolute key of the audio content; intensity; and/or classification such as classical, pop, discussion, movie. Further, data may be analyzed that is separate from the audio content itself, but that may be associated with the audio data, such as meta-data that is associated with the audio content. As may be readily appreciated by a person of ordinary skill in the art, any systems of discerning characteristics of the audio content may be applied for producing the audio-based ambient lighting data in accordance with the present system.

The audio-based ambient lighting data may include data to control ambient lighting characteristics such as dynamics (e.g., brightness, saturation, etc.) of one or more ambient lighting elements as well as modulate video based ambient lighting characteristics as described herein. The audio-based ambient lighting data may be utilized to determine data to control ambient lighting characteristics that are similar and/or complementary to the determined video-based ambient lighting characteristics.

During act 160, the video-based ambient lighting data and the audio-based ambient lighting data are combined to form combined ambient lighting data. Typically, video content and audio content are synchronized in audio-visual content. As such, the video-based ambient lighting data and the audio-based ambient lighting data are provided as temporal sequences of data. Accordingly, temporal portions of the video-based ambient lighting data and the audio-based ambient lighting data may be combined to produce the combined ambient lighting data that also is synchronized to the audio-visual content and may be rendered as such during act 170. After rendering, the process ends during act 180.

In one embodiment in accordance with the present system, the video-based ambient lighting data may be utilized to determine color characteristics of the ambient lighting data, such as color points. The audio-based ambient lighting data may then be applied to modulate the color points, such as adjusting dynamics of the video-determined color points.

For example, in an audio-visual sequence wherein the video-based ambient lighting data determines to set a given ambient lighting characteristics to a given color point during a given temporal portion, the audio-based ambient lighting data in combining with the video-based ambient lighting data may adjust the color to a dimmer (e.g., less bright) color based on low audio energy during the corresponding audio-visual sequence. Similarly, in an audio-visual sequence wherein the video-based ambient lighting data determines to set ambient lighting characteristics to a given color point, the audio content may adjust the color to a brighter color based on high audio energy during the corresponding audio-visual sequence. Clearly, other systems for combining the video-based ambient lighting data and the audio-based ambient lighting data would occur to a person of ordinary skill in the art and are intended to be understood to be within the bounds of the present system and appended claims. In this way, the combined ambient lighting data may be utilized to control one or more ambient lighting elements to respond to both of rendered audio and corresponding video content. In one embodiment in accordance with the present system, a user may adjust the influence that each of the audio and video content has on the combined ambient lighting data. For example, the user may decide that the audio-based ambient lighting data has a lessened or greater effect on the video-based ambient lighting data in determining the combined ambient lighting data.

In a further embodiment, the audio content and video content may be separate content not previously arranged as audio-visual content. For example, an image or video sequence may have audio content intended for rendering during the image or video sequence. In accordance with the present system, the video-based ambient lighting data may be modulated by the audio-based ambient lighting data similar as provided above for the audio-visual content. In a further embodiment, multiple audio portions may be provided for rendering with video content. In accordance with the present system, one and/or the other of the audio portions may be utilized for determining the audio-based ambient lighting data.

While FIG. 1 shows the video-based ambient lighting data and the audio-based ambient lighting data being received separately, clearly there is no need to have to have each received separately. For example, a received ambient lighting script may be produced that is determined based on both of audio and visual characteristics of audio-visual content. Further acts 130 and 150 may be provided substantially simultaneously so that combined ambient lighting data is produced directly without a need to produce separate video-based ambient lighting data and audio-based ambient lighting data that is subsequently combined. Other variations would readily occur to a person of ordinary skill in the art and are intended to be included within the present system.

In an embodiment in accordance with the present system, in combining the video-based ambient lighting data and the audio-based ambient lighting data, the audio-based ambient lighting data may be utilized to determine audio-based ambient lighting characteristics similar as discussed for the video-based ambient lighting data, which are thereafter modulated by the video-based ambient lighting data. For example, in one embodiment, characteristics of the audio-based ambient lighting data may be mapped to characteristics of the ambient lighting. In this way, a characteristic of the audio, such as a given number of beats per minute of the audio data, may be mapped to a given color of the ambient lighting. For example, a determined ambient lighting color may be mapped to a range of beats per minute. Naturally, other characteristics of the audio and ambient lighting may be readily, similarly, mapped.

In yet another embodiment, the video-based ambient lighting characteristics may be modulated such that an audio-based pattern is produced utilizing colors determined from the video-based ambient characteristics, similar to a VU-meter presentation as may be readily appreciated by a person of ordinary skill in the art. For example, in a pixilated ambient lighting system, individual portions of the pixilated ambient lighting system may be modulated by the audio-based ambient lighting data. In a VU-meter like presentation, the audio-modulation of the presentation may be provided from a bottom portion progressing upwards in an ambient lighting system or the reverse (e.g., top progressing downwards) may be provided. Further, the progression may be from left to right or outwards from a center portion of the ambient lighting system.

As may be further appreciated, since audio-based ambient lighting data may typically be different for different channels of the audio data, including left data, right data, center data, rear left data, rear right data, etc., each of these positional audio-data portions, or parts thereof may be readily utilized in combination with the video-based ambient lighting data and characteristics. For example, a portion of the video-based ambient lighting characteristics intended for presentation on a left side of a display may be combined with a left-channel of the audio-based ambient lighting data while a portion of the video-based ambient lighting characteristics intended for presentation on a right side of the display may be combined with a right-channel of the audio-based ambient lighting data. Other combinations of portions of the video-based ambient lighting data and portions of the audio-based ambient lighting data may be readily applied.

FIG. 2 shows a device 200 in accordance with an embodiment of the present system. The device has a processor 210 operationally coupled to a memory 220, a video rendering device (e.g., display) 230, an audio rendering device (e.g., speakers) 280, ambient lighting elements 250, 260, an input/output (I/O) 240 and a user input device 270. The memory 220 may be any type of device for storing application data as well as other data, such as ambient lighting data, audio data, video data, mapping data, etc. The application data and other data are received by the processor 210 for configuring the processor 210 to perform operation acts in accordance with the present system. The operation acts include controlling at least one of the display 230 to render content and controlling one or more of the ambient lighting elements 250, 260 to display ambient lighting effects in accordance with the present system. The user input 270 may include a keyboard, mouse, or other devices, including touch sensitive displays, which may be stand alone or be a part of a system, such as part of a personal computer, personal digital assistant, and display device such as a television, for communicating with the processor via any type of link, such as a wired or wireless link. Clearly the processor 210, memory 220, display 230, ambient lighting elements 250, 260 and/or user input 270 may all or partly be a portion of a television platform, such as a stand-alone television or may be standalone devices.

The methods of the present system are particularly suited to be carried out by a computer software program, such computer software program preferably containing modules corresponding to the individual steps or acts of the methods. Such software may of course be embodied in a computer-readable medium, such as an integrated chip, a peripheral device or memory, such as the memory 220 or other memory coupled to the processor 210.

The computer-readable medium and/or memory 220 may be any recordable medium (e.g., RAM, ROM, removable memory, CD-ROM, hard drives, DVD, floppy disks or memory cards) or may be a transmission medium (e.g., a network comprising fiber-optics, the world-wide web, cables, or a wireless channel using time-division multiple access, code-division multiple access, or other radio-frequency channel). Any medium known or developed that can provide information suitable for use with a computer system may be used as the computer-readable medium and/or memory 220.

Additional memories may also be used. The computer-readable medium, the memory 220, and/or any other memories may be long-term, short-term, or a combination of long-term and short-term memories. These memories configure processor 210 to implement the methods, operational acts, and functions disclosed herein. The memories may be distributed or local and the processor 210, where additional processors may be provided, may also be distributed, as for example based within the ambient lighting elements, or may be singular. The memories may be implemented as electrical, magnetic or optical memory, or any combination of these or other types of storage devices. Moreover, the term “memory” should be construed broadly enough to encompass any information able to be read from or written to an address in the addressable space accessed by a processor. With this definition, information on a network is still within memory 220, for instance, because the processor 210 may retrieve the information from the network for operation in accordance with the present system.

The processor 210 is capable of providing control signals and/or performing operations in response to input signals from the user input 270 and executing instructions stored in the memory 220. The processor 210 may be an application-specific or general-use integrated circuit(s). Further, the processor 210 may be a dedicated processor for performing in accordance with the present system or may be a general-purpose processor wherein only one of many functions operates for performing in accordance with the present system. The processor 210 may operate utilizing a program portion, multiple program segments, or may be a hardware device utilizing a dedicated or multi-purpose integrated circuit.

The I/O 240 may be utilized for transferring a content identifier, for receiving one or more light scripts, and/or for other operations as described above.

Of course, it is to be appreciated that any one of the above embodiments or processes may be combined with one or more other embodiments or processes or be separated in accordance with the present system.

Finally, the above-discussion is intended to be merely illustrative of the present system and should not be construed as limiting the appended claims to any particular embodiment or group of embodiments. Thus, while the present system has been described with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts or steps is intended to be required unless specifically indicated.

1. A method of controlling an ambient lighting element, the method comprising acts of:
processing combined ambient lighting data, wherein the combined ambient lighting data is based on video content portions and corresponding audio content portions; and
controlling an ambient lighting element based on the processed combined ambient lighting data.

2. The method of claim 1, comprising an act of
receiving the combined ambient lighting data as a combined ambient lighting script.

3. The method of claim 1, comprising acts of:
receiving video-based ambient lighting data;
receiving audio-based ambient lighting data; and
combining the received video-based ambient lighting data and the received audio-based ambient lighting data to produce the combined ambient lighting data.

4. The method of claim 3, wherein the act of combining comprises the act of modulating the video-based ambient lighting data by the audio-based ambient lighting data.

5. The method of claim 3, comprising an act of analyzing the video content to produce the video-based ambient lighting data.

6. The method of claim 5, wherein the act of analyzing the video content comprises an act of determining a plurality of color points as the video-based ambient lighting data.

7. The method of claim 3, comprising an act of analyzing the audio content to produce the audio-based ambient lighting data.

8. The method of claim 7, wherein the act of analyzing the audio content comprises an act of analyzing at least one of a frequency, a frequency range, and an amplitude of the corresponding audio content portions.

9. The method of claim 7, wherein the act of analyzing the audio content comprises an act of analyzing temporal portions of the audio content to produce temporal portions of audio-based ambient lighting data.

10. The method of claim 7, wherein the act of analyzing the audio content comprises an act of analyzing positional portions of the audio content to produce positional portions of audio-based ambient lighting data.

11. The method of claim 3, wherein the act of combining comprises acts of:
determining a color point based on the received video-based ambient lighting data; and
utilizing the audio-based ambient lighting data to adjust dynamics of the color point.

12. An application embodied on a computer readable medium configured to control an ambient lighting element, the application comprising:
a portion configured to process combined ambient lighting data, wherein the combined ambient lighting data corresponds to video content portions and audio content portions; and
a portion configured to control an ambient lighting element based on the processed combined ambient lighting data.

13. The application of claim 12, comprising:
a portion configured to receive video-based ambient lighting data;
a portion configured to receive audio-based ambient lighting data; and
a portion configured to combine the received video-based ambient lighting data and the received audio-based ambient lighting data to produce the combined ambient lighting data.

14. The application of claim 12, comprising:
a portion configured to analyze the video content to produce the video-based ambient lighting data, wherein the portion configured to analyze the video content is configured to determine a color point as the video-based ambient lighting data.

15. The application of claim 12, comprising a portion configured to analyze the audio content to produce the audio-based ambient lighting data, wherein the portion configured to analyze the audio content is configured to analyze portions of the audio content to produce portions of audio-based ambient lighting data as the audio-based ambient lighting data.

16. The application of claim 15, wherein the portions of audio-based ambient lighting data are at least one of positionally and temporally apportioned.

17. The application of claim 15, wherein the portion configured to analyze the audio content is configured to analyze at least one of a frequency, a frequency range, and an amplitude of the corresponding audio content portions.

18. The application of claim 12, comprising a portion configured to determine a color point based on the video-based ambient lighting data, wherein the portion configured to combine is configured to utilize the audio-based ambient lighting data to adjust dynamics of the color point.

19. A device for controlling an ambient lighting element, the device comprising:
a memory (220); and
a processor (210) operationally coupled to the memory (220), wherein the processor (210) is configured to:
analyze video content to produce video-based ambient lighting data;
analyze audio content to produce audio-based ambient lighting data; and
combine the video-based ambient lighting data and the audio-based ambient lighting data to produce combined ambient lighting data.

20. The device of claim 19, wherein the processor (210) is configured to:
analyze the video content to produce a color point as the video-based ambient lighting data; and
utilize the audio-based ambient lighting data to modulate the color point.

21. The device of claim 19, wherein the processor (210) is configured to analyze at least one of temporal and positional portions of the audio content to produce the audio-based ambient lighting data.
